(19) United States
(12) Patent Application Publication
(10) Pub. No.: US 2008/0249854 A1
(43) Pub. Date: Oct. 9, 2008

(54) MONETIZING LOW VALUE CLICKERS

(75) Inventors: Kavel PATEL, Sunnyvale, CA (US); Raj Gopal Prasad KANTAMNENI, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/697,452

(22) Filed: Apr. 6, 2007

(51) Int. Cl. G06Q 30/00

(52) U.S. Cl. 705/14

(57) ABSTRACT

A solution is provided wherein an identification of a user who is producing low value to a web page or service is received, wherein the identification was determined by measuring web page usage patterns for the user. Advertising is then presented on the web page or service for the user according to a retraining program, wherein the retraining program is designed to retrain the user's behavior so that the user no longer produces low value and wherein the retraining program presents advertising in a different way than would be presented without the retraining program.

### CROSS-REFERENCE TO RELATED APPLICATION

This application is related to U.S. patent application Ser. No. 11/617,788, entitled “Propensity-to-Click Targeting and Modeling” (Attorney Docket No. YAH1P047), filed Dec. 19, 2006, by Kavel Patel.

### BACKGROUND OF THE INVENTION

1. Field of the Invention

The present invention relates to the field of Internet searching. More specifically, the present invention relates to the monetization of clickers who ordinarily do not generate much income.

2. Description of the Related Art

When searching for results in an Internet search engine, it is common for advertisements to be displayed on the web page displaying the results of the search. FIG. 1 is a screen capture illustrating a search for the terms “iPod,” “nano,” “white,” and “buy.” As can be seen, ads 100 may be displayed above the search results 102. The ads 100 displayed above search results are often called “North” ads. Ads 104 may also be displayed below the search results 102. These ads 104 are often called “South” ads. “East” ads 106 may be displayed to the right of the search results 102. Search results 102 are sometimes called “natural” results. It should be noted that throughout this document, the term “search engine” should be read to include any service that provides web page searching capabilities, which may include services alternatively known as “directories.”

The advertisements may take the form of sponsored search results, wherein sponsors pay to have particular search term combinations return a results page in which the sponsor's links are also displayed (along with, perhaps, a short description of the link). Sponsors often pay for such advertising on a per-click basis, wherein the total advertising charge is based on the number of times users click on the sponsored link.

A significant number of searchers, however, do not click on advertisements. Of those that do click, a small percentage are very heavy searchers and clickers, driving larger overall click volumes. This results in the less-than-ideal situation where a small number of users are driving large portions of the revenue stream. Thus, the success or failure of a revenue stream is based on the actions of a small number of users. What is needed is a way to remedy this situation by turning those users who tend not to click on advertisements into revenue streams.

### SUMMARY OF THE INVENTION

A solution is provided wherein an identification of a user who is producing low value to a web page or service is received, wherein the identification was determined by measuring web page usage patterns for the user. Advertising is then presented on the web page or service for the user according to a retraining program, wherein the retraining program is designed to retrain the user's behavior so that the user no longer produces low value and wherein the retraining program presents advertising in a different way than would be presented without the retraining program.

### BRIEF DESCRIPTION OF THE DRAWINGS

FIG. 1 is a screen capture illustrating a search for the terms “iPod,” “nano”, “white,” and “buy.”

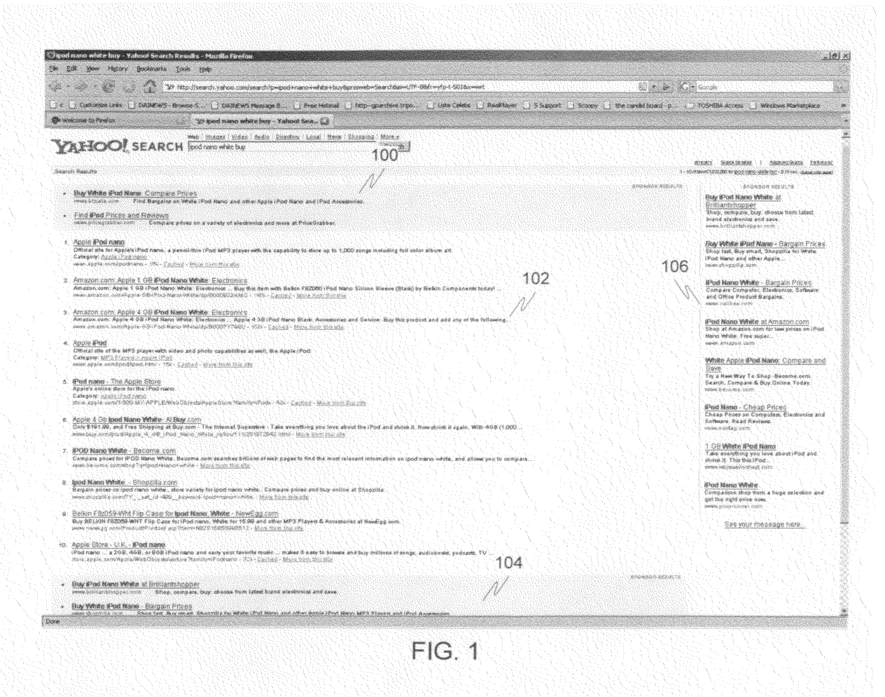

FIG. 2 is a flow diagram illustrating a method for monetizing users of a web page or service in accordance with an embodiment of the present invention.

FIG. 3 is a block diagram illustrating an apparatus for monetizing users of a web page or service in accordance with an embodiment of the present invention.

FIG. 4 is an exemplary network diagram illustrating some of the platforms which may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

During the inventive process surrounding the present invention, a significant amount of research was conducted to measure the usage patterns of users performing searchers. In this research, it was unexpectedly discovered that many users have what can be termed as “banner blindness,” wherein they immediately focus on the main algorithmic results of a search and ignore advertisements on the returned web page. This behavior is learned behavior, and is based on reflexive memory involving minimal cognitive effort on the users part. Over time this becomes a deeply ingrained, learned behavior. This realization resulted in approaching the problem from a completely new perspective—i.e., from the user perspective, and finding a way to alter this learned behavior.

In one embodiment of the present invention, advertisements are removed from returned web pages for user have been labeled as “low value” users. A user is “low value” if he or she typically does not generate a significant amount of revenue for the search engine. This may be measured by examining web usage patterns over a period of time (e.g., minutes, days, months, etc.) or sessions. By removing the advertisements, users are slowly retrained to observe the entire results page as opposed to merely focusing on algorithmic results. Slowly such advertisements may then be re-introduced into results pages, and the user then notices these advertisements because the previously learned behavior has been reduced or eliminated and replaced with a behavior that is more beneficial to the search engine. The information regarding whether a user is deemed to be low value may be stored so that subsequent sessions can utilize this information.

One potential drawback to this embodiment is that users may then develop a tolerance again once advertising returns to normal. As such, in another embodiment of the present invention, a random reinforcement cycle is implemented. In this embodiment, most of the time advertisements are not shown to low value clickers. However, once in a while (either via a set period or randomly according to a set percentage), advertisements are shown. This prevents the user from re-learning the banner blindness behavior.

In this embodiment, the period between advertisement showing may vary based on a number of different factors. One of these factors may be the relevance of the advertisement to the user. This relevance may be based on, for example, the query entered by the user. For example, if the user queried on “White iPod Video 60 gb”, then a general advertisement for iPods may be less relevant to this query than a specific advertisement for an Ipod Video 60 gb unit. Likewise a general electronics advertisement may be less relevant for this query than the general iPod advertisement. Other factors may be used in conjunction with, or in addition to, the query to determined relevance. These may include, for example, geographic location, user history, user profile, etc.

Furthermore, more factors than merely the period between advertisements may be varied to obtain an optimum yet seemingly random effect. For example, the number of advertisements displayed may be varied.

Other embodiments are envisioned with various other retraining programs. Some of these will be discussed herein but it should be noted that the invention is not limited to the retraining programs explicitly recited here.

The retraining program utilized may differ based on user characteristics, such as age, gender, geographic location, occupation, race, religion, sexual preference, etc.

The retraining program utilized may also include elements other than advertisements. For example, instead of simply not showing ads and making the algorithmic results on a results page more prominent, the program may display actual content in the areas where advertisements would normally go. This might include, for example, search tips. The presence of such content would actually act to direct users eyes towards the areas where advertisements could be placed as opposed to merely passively not displaying ads (i.e., not scaring users off).

Indeed, the retraining program need not be used to introduced advertisements at all. The same retraining programs could be utilized to focus user attention on actual content that the search engine wishes for them to observe.

The retraining program utilized may also alter the presentation of advertisements even when advertisements are chosen to be displayed. Besides the aforementioned varying of the number of advertisements displayed, the system may also vary the location, font, font size, graphic vs. text, and other visual elements of the advertisements.

The retraining program may also alter the presentation of the algorithmic results in order to better highlight advertisements or areas of the screen where advertisements could be placed.

The retraining program may also introduce interstitial advertisements as part of the retraining process.

In another embodiment of the present invention, the retraining program may be altered dynamically based on a score assigned to a user. This score may, for example, reflect the value of the user. For example, as the value goes down, the retraining program may be more likely to institute heavy retraining processes, such as complete removal of advertisements and reintroduction with a long period between advertisements. As the value then proceeds to go up as the user unleams the banner blindness, the retraining program may ease up, shortening the period between advertisements.

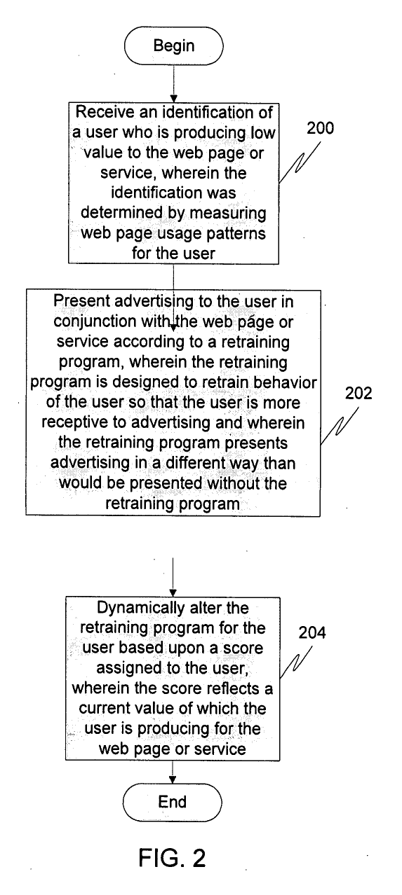

FIG. 2 is a flow diagram illustrating a method for monetizing users of a web page or service in accordance with an embodiment of the present invention. The web page or service may be a search engine. At 200, an identification of a user who is producing low value to the web page or service is received, wherein the identification was determined by measuring web page usage patterns for the user. The user who is producing low value to the web page or service may be, for example, a user who rarely clicks on advertisements on the web page or service. At 202, advertising is presented to the user in conjunction with the web page or service according to a retraining program, wherein the retraining program is designed to retrain behavior of the user so that the user is more receptive to advertising and wherein the retraining program presents advertising in a different way than would be presented without the retraining program. The retraining program may take many forms. For example, the retraining program may cyclically reduce advertising coverage on the web page or service for the user for predefined periods of time. Cyclically reducing advertising means to reduce advertising on some page views of a particular web page or service while not reducing it on others, but to do so in a regular cycle. Alternatively, the retraining program may reduce advertising coverage for certain page views of the web page or service for the user such that a set percentage of page views of the web page or service appear with reduced advertising coverage and the rest of the page views of the web page or service appear with normal advertising coverage. The reducing of advertising coverage may itself take many different forms. For example, it may simply involve reducing the number of advertisements displayed to the user. It may also include reducing or increasing the size or altering other display characteristics of advertisements displayed to the user. It may also include introducing content relevant to the user in place of advertisements on the web page or service, such as search tips.

The retraining program may also vary based on user characteristics other than whether the user produces low value to the web page or service. These characteristics could include, for example, age, gender, geographic location, occupation, race, religion, and sexual preference.

At 204, the retraining program may be dynamically altered for the user based upon a score assigned to the user, wherein the score reflects a current value of which the user is producing for the web page or service.

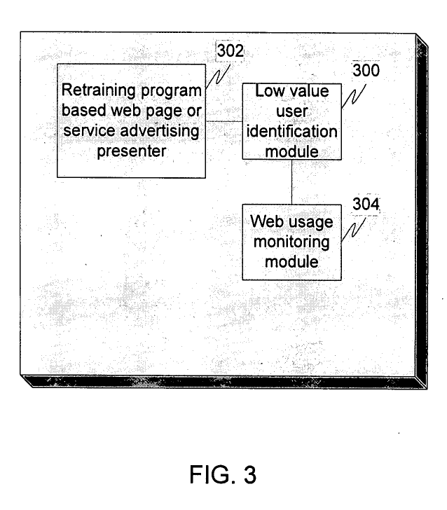

FIG. 3 is a block diagram illustrating an apparatus for monetizing users of a web page or service in accordance with an embodiment of the present invention. A low value user identification receiver 300 may be configured to perform the processes described above in 200 of FIG. 2 and the corresponding text. A retraining program based web page or service advertising presenter 302 coupled to the low value user identification receiver 300 may be configured to perform the processes described above in 202 of FIG. 2 and the corresponding text.

A web usage monitoring module 304 may be coupled to the low value user identification receiver 300 and configured to monitor user web behavior with respect to the production of value to the web page or service. This web page monitoring module 304 may be further configured to track a user's propensity to click on advertising. This web page monitoring module 304 may also work with the low value user identification receiver 300 and the retraining program based web page or service advertising presenter 302 to perform the processes described above in 204 of FIG. 2 and the corresponding text.

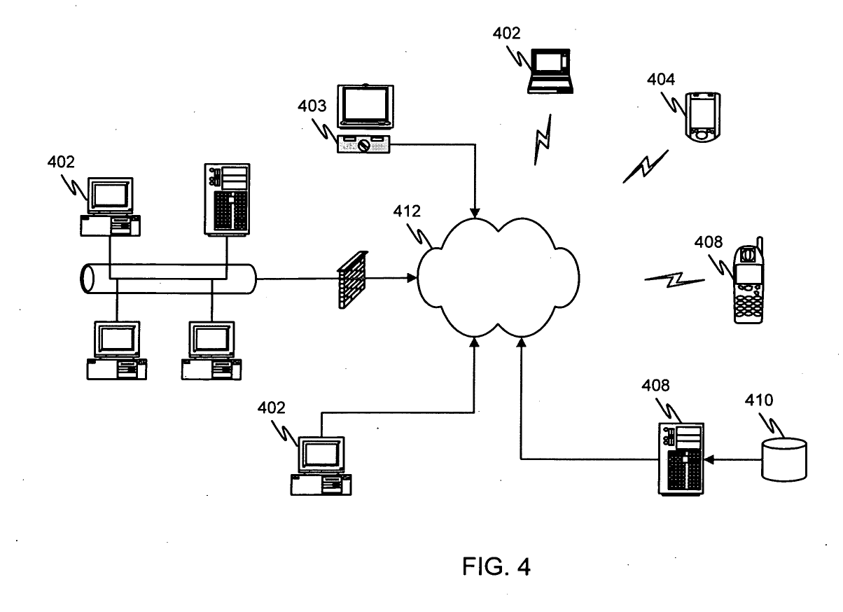

It should also be noted that the present invention may be implemented on any computing platform and in any network topology in which search categorization is a useful functionality. For example and as illustrated in FIG. 4, implementations are contemplated in which the retraining programs described herein are employed in a network containing personal computers 402, media computing platforms 403 (e.g., cable and satellite set top boxes with navigation and recording capabilities (e.g., Tivo)), handheld computing devices (e.g., PDAs) 404, cell phones 406, or any other type of portable communication platform. Users of these devices may conduct searches, which are then transmitted to server 408. Server 408 may then utilize the propensity-to-click score in determining various different activities to take with respect to the user. As discussed above, applications may be resident on such devices, e.g., as part of a browser or other application, or be served up from a remote site, e.g., in a Web page, (represented by server 408 and data store 410). The invention may also be practiced in a wide variety of network environments (represented by network 412), e.g., TCP/IP-based networks, telecommunications networks, wireless networks, etc.

While the invention has been particularly shown and described with reference to specific embodiments thereof, it will be understood by those skilled in the art that changes in the form and details of the disclosed embodiments may be made without departing from the spirit or scope of the invention. For example, it will be understood that the various propensity-to-click metrics referred to herein are merely examples of metrics which may be employed with embodiments of the invention, and that embodiments are contemplated in which a wide variety of metrics may be employed in various combinations. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for increasing the likelihood of monetization of users of a web page or service, the method comprising:
receiving an identification of a user who is producing low value to the web page or service, wherein the identification was determined by measuring web page usage patterns for the user; and
presenting advertising to the user in conjunction with the web page or service according to a retraining program, wherein the retraining program is designed to retrain behavior of the user so that the user is more receptive to advertising and wherein the retraining program presents advertising in a different way than would be presented without the retraining program.

2. The method of claim 1, wherein the user who is producing low value to the web page or service is a user who rarely clicks on advertisements on the web page or service.

3. The method of claim 1, wherein the web page or service is a search engine.

4. The method of claim 1, wherein the retraining program cyclically reduces advertising coverage on the web page or service for the user for predefined periods of time.

5. The method of claim 1, wherein the retraining program reduces advertising coverage for certain page views of the web page or service for the user such that a set percentage of page views of the web page or service appear with reduced advertising coverage and the rest of the page views of the web page or service appear with normal advertising coverage.

6. The method of claim 4, wherein the reducing of advertising coverage includes reducing the number of advertisements displayed to the user.

7. The method of claim 4, wherein the reducing of advertising coverage includes reducing the size of advertisements displayed to the user.

8. The method of claim 4, wherein the reducing of advertising coverage includes introducing content relevant to the user in place of advertisements on the web page or service.

9. The method of claim 1, wherein the retraining program varies based on user characteristics other than whether the user produces low value to the web page or service.

10. The method of claim 9, wherein the user characteristics include one or more characteristics selected from the group consisting of: age, gender, geographic location, occupation, race, religion, and sexual preference.

11. The method of claim 1, further comprising:
dynamically altering the retraining program for the user based upon a score assigned to the user, wherein the score reflects a current value of which user is producing for the web page or service.

12. An apparatus for monetizing users of a web page or service, the apparatus comprising:
a low value user identification receiver configured receive an identification of a user who is producing low value to the web page or service, wherein the identification was determined by measuring web page usage patterns for the user; and; and
a retraining program based web page or service advertising presenter coupled to the low value user identification receiver and configured to present advertising to the user in conjunction with the web page or service according to a retraining program, wherein the retraining program is designed to retrain behavior of the user so that the user is more receptive to advertising and wherein the retraining program presents advertising in a different way than would be presented without the retraining program.

13. The apparatus of claim 12, further comprising a web usage monitoring module coupled to the low value user identification receiver and configured to monitor user web behavior with respect to the production of value to the web page or service.

14. The apparatus of claim 13, wherein the web page monitoring module is further configured to track a user's propensity to click on advertising.

15. An apparatus for monetizing users of a web page or service, the apparatus comprising:
means for receiving an identification of a user who is producing low value to the web page or service, wherein the identification was determined by measuring web page usage patterns for the user; and
means for presenting advertising to the user in conjunction with the web page or service according to a retraining program, wherein the retraining program is designed to retrain behavior of the user so that the user is more receptive to advertising and wherein the retraining program presents advertising in a different way than would be presented without the retraining program.
